(19) United States
(12) Patent Application Publication
(10) Pub. No.: US 2025/0123225 A1
(43) Pub. Date: Apr. 17, 2025

(54) SPECTRA DELTA METROLOGY

(71) Applicant: KLA Corporation, Milpitas, CA (US)

(72) Inventors: Houssam Chouaib, San Jose, CA (US); Zhengquan Tan, Cupertino, CA (US); HaoMiao Chang, Chupei City (TW); Valeria Dimastrodonato, Portland, OR (US); Anderson Chou, Hillsboro, OR (US); Boxue Chen, San Jose, CA (US)

(21) Appl. No.: 18/613,874

(22) Filed: Mar. 22, 2024

Related U.S. Application Data
(60) Provisional application No. 63/544,448, filed on Oct. 17, 2023.

(51) Int. Cl. G01N 23/2251

(52) U.S. Cl. CPC G01N 23/2251; G01N 2223/304; G01N 2223/305

(57) ABSTRACT

An inspection system may receive first measurement data of training samples after a first process step with an in-line measurement sub-system, where the first process step is prior to fabrication of a test feature on the one or more training samples; and receive second measurement data of the test feature after a second process step, where the second process step is after fabrication of the test feature. An inspection system may determine delta metrics associated with the first and second measurement data for the test feature. An inspection system may generate a measurement model for determining metrology measurements of the test feature based on at least one of the second measurement data or the delta metrics. An inspection system may determine values of the metrology measurements for additional instances of the test feature based on at least one of the second measurement data or the delta metrics.

### CROSS-REFERENCE TO RELATED APPLICATION

The present application claims the benefit under 35 U.S.C. § 119 (e) of U.S. Provisional Application Ser. No. 63/544,448, filed Oct. 17, 2023, entitled SPECTRA DELTA METROLOGY, naming Houssam Chouaib, Zhengquan Tan, HaoMiao Chang, Valeria Dimastrodonato, Anderson Chou, and Boxue Chenas inventors, which is incorporated herein by reference in the entirety.

### TECHNICAL FIELD

The present disclosure relates generally to metrology and/or defect inspection and, more particularly, to metrology and/or defect inspection based on differences between measurement data between process steps of interest.

### BACKGROUND

Many current optical metrology applications for integrated circuit manuficaturing require complex spectroscopic analysis. Further, the number of critical process steps requiring sensitive metrology is continuing to increase while the window of tolerance and the precision limits of inspection techniques are tightening signficantly.

In some applications, it is desirable to characterize a sample after a process step that produces a relatively subtle physical change to the sample. However, such process steps may produce correspondingly subtle changes to optical measurement data. As a result, optical characterization techniques used to identify defects in such a process may suffer from noise and/or a lack of sensitivity.

There is therefore a need to develop systems and methods to address the above deficiencies.

### SUMMARY

In embodiments, the techniques described herein relate to an inspection system including a controller including one or more processors configured to execute program instructions causing the one or more processors to receive first measurement data of one or more training samples after a first process step with an in-line measurement sub-system, where the first process step is prior to fabrication of a plurality of instances of a test feature on the one or more training samples; receive second measurement data of the plurality of instances of the test feature after a second process step with the in-line measurement sub-system, where the second process step is after the fabrication of the plurality of instances of the test feature, where the plurality of instances of the test feature provide a distribution of intentional variations of one or more aspects of the test feature; determine one or more delta metrics associated with the first and second measurement data for the plurality of instances of the test feature; generate, using the second measurement data and the one or more delta metrics, a measurement model for determining metrology measurements of the test feature based on at least one of the second measurement data or the one or more delta metrics; and determine values of the metrology measurements for one or more additional instances of the test feature based on at least one of the second measurement data or the one or more delta metrics associated with the one or more additional instances of the test feature generated with the in-line measurement sub-system.

In embodiments, the techniques described herein relate to an inspection system, where the one or more delta metrics are based on at least one of a root mean square error (RMSE), a difference, an absolute difference, a sum, or an absolute sum of the first and second measurement data.

In embodiments, the techniques described herein relate to an inspection system, where the program instructions are further configured to cause the one or more processors to receive ground-truth metrology measurements of the plurality of instances of the test feature after the second process step with a reference measurement sub-system different than the in-line measurement sub-system; and generate reference data based on the ground-truth metrology measurements and the one or more delta metrics, where generate, using the second measurement data and the one or more delta metrics, the measurement model for determining metrology measurements of the plurality of instances of the test feature based on at least the second measurement data includes generate, using the second measurement data and the reference data, the measurement model for determining metrology measurements of the plurality of instances of the test feature based on at least the second measurement data.

In embodiments, the techniques described herein relate to an inspection system, where generate the reference data based on the ground-truth metrology measurements and the one or more delta metrics includes determine a fitting function relating the ground-truth metrology measurements to the one or more delta metrics; and generate the reference data based on the fitting function.

In embodiments, the techniques described herein relate to an inspection system, where the in-line measurement sub-system includes an optical measurement sub-system.

In embodiments, the techniques described herein relate to an inspection system, where the reference measurement sub-system includes at least one of an x-ray measurement sub-system or a particle-beam measurement sub-system.

In embodiments, the techniques described herein relate to an inspection system, where the in-line measurement sub-system includes a critical dimension scanning electron microscope system.

In embodiments, the techniques described herein relate to an inspection system, where the reference measurement sub-system includes at least one of an x-ray photon spectrometer system or a transmission electron microscope system.

In embodiments, the techniques described herein relate to an inspection system, where the measurement model includes a machine learning model trained on the second measurement data and at least one of the one or more delta metrics or the reference data.

In embodiments, the techniques described herein relate to an inspection system, where the in-line measurement sub-system includes an optical measurement sub-system, where the measurement model includes an electromagnetic model.

In embodiments, the techniques described herein relate to an inspection system, where the electromagnetic model includes a rigorous coupled-wave analysis (RCWA) model.

In embodiments, the techniques described herein relate to an inspection system, where the measurement model includes a machine learning model trained on the second measurement data and the one or more delta metrics.

In embodiments, the techniques described herein relate to an inspection system, where the in-line measurement sub-system includes an optical measurement sub-system, where the measurement model includes an electromagnetic model.

In embodiments, the techniques described herein relate to an inspection system, where the electromagnetic model includes a rigorous coupled-wave analysis (RCWA) model.

In embodiments, the techniques described herein relate to an inspection system, where the in-line measurement sub-system includes an optical measurement sub-system.

In embodiments, the techniques described herein relate to an inspection system, where the optical measurement sub-system is configured to determine at least some Mueller matrix elements associated with the plurality of instances of the test feature.

In embodiments, the techniques described herein relate to an inspection system, where the in-line measurement sub-system includes a particle-beam measurement sub-system.

In embodiments, the techniques described herein relate to an inspection system, where the in-line measurement sub-system includes an x-ray measurement sub-system.

In embodiments, the techniques described herein relate to an inspection method including generating first measurement data of one or more training samples after a first process step with an in-line measurement sub-system, where the first process step is prior to fabrication of a plurality of instances of a test feature on the one or more training samples; generating second measurement data of the plurality of instances of the test feature after a second process step with the in-line measurement sub-system, where the second process step is after fabrication of the test feature, where the plurality of instances of the test feature provide a distribution of intentional variations of one or more aspects of the test feature; determining one or more delta metrics associated with the first and second measurement data for the plurality of instances of the test feature; generating, using the second measurement data and the one or more delta metrics, a measurement model for determining metrology measurements of the test feature based on at least one of the second measurement data or the one or more delta metrics; and determining values of the metrology measurements for one or more additional instances of the test feature based on at least one of the second measurement data or the one or more delta metrics associated with the one or more additional instances of the test feature generated with the in-line measurement sub-system.

In embodiments, the techniques described herein relate to an inspection system including an in-line measurement sub-system; a reference measurement sub-system; and a controller including one or more processors configured to execute program instructions causing the one or more processors to receive first measurement data of one or more training samples after a first process step with the in-line measurement sub-system, where the first process step is prior to fabrication of a plurality of instances of a test feature on the one or more training samples; receive second measurement data of the plurality of instances of the test feature after a second process step with the in-line measurement sub-system, where the second process step is after the fabrication of the plurality of instances of the test feature, where the plurality of instances of the test feature provide a distribution of intentional variations of one or more aspects of the test feature; determine one or more delta metrics associated with the first and second measurement data for the plurality of instances of the test feature; receive ground-truth metrology measurements of the plurality of instances of the test feature after the one or more second process steps with the reference measurement sub-system; generate reference data based on the ground-truth metrology measurements and the one or more delta metrics; generate, using the second measurement data and the reference data, a measurement model for determining metrology measurements of the plurality of instances of the test feature based on at least the second measurement data; and determine values of the metrology measurements for one or more additional instances of the test feature based on at least one of the second measurement data or the one or more delta metrics associated with the one or more additional instances of the test feature generated with the in-line measurement sub-system.

In embodiments, the techniques described herein relate to an inspection system, where generate the reference data based on the ground-truth metrology measurements and the one or more delta metrics includes determine a fitting function relating the ground-truth metrology measurements to the one or more delta metrics; and generate the reference data based on the fitting function.

In embodiments, the techniques described herein relate to an inspection system, where the in-line measurement sub-system includes an optical measurement sub-system.

In embodiments, the techniques described herein relate to an inspection system, where the optical measurement sub-system is configured to determine at least some Mueller matrix elements associated with the plurality of instances of the test feature.

In embodiments, the techniques described herein relate to an inspection system, where the reference measurement sub-system includes at least one of an x-ray measurement sub-system or a particle-beam measurement sub-system.

In embodiments, the techniques described herein relate to an inspection system, where the in-line measurement sub-system includes a particle-beam measurement sub-system.

In embodiments, the techniques described herein relate to an inspection system, where the in-line measurement sub-system includes a critical dimension scanning electron microscope system.

In embodiments, the techniques described herein relate to an inspection system, where the reference measurement sub-system includes at least one of an x-ray photon spectrometer system or a transmission electron microscope system.

In embodiments, the techniques described herein relate to an inspection system, where the in-line measurement sub-system includes an x-ray measurement sub-system.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a block diagram of a metrology system in accordance with one or more embodiments of the present disclosure.

FIG. 1B is a simplified schematic of an optical measurement sub-system, in accordance with one or more embodiments of the present disclosure.

FIG. 1C is a simplified schematic of an x-ray measurement sub-system, in accordance with one or more embodiments of the present disclosure.

FIG. 1D is a simplified schematic of a particle beam measurement sub-system 102, in accordance with one or more embodiments of the present disclosure.

FIG. 2 is a flow diagram depicting steps performed in a metrology method, in accordance with one or more embodiments of the present disclosure.

FIG. 3A is a cross-section view of a VNAND device after a first process step prior to fabricating a bottom open recess test feature, in accordance with one or more embodiments of the present disclosure.

FIG. 3B is a cross-section view of the VNAND device of FIG. 3A after a second process step fabricating a bottom open recess test feature, in accordance with one or more embodiments of the present disclosure.

FIG. 4A is a cross-section view of a VNAND device after a first process step prior to fabricating a recess test feature, in accordance with one or more embodiments of the present disclosure.

FIG. 4B is a magnified view of a portion of FIG. 4A after the first process step, in accordance with one or more embodiments of the present disclosure.

FIG. 4C is a magnified view of the portion of FIG. 4A after a second process step forming the recess test feature, in accordance with one or more embodiments of the present disclosure.

FIG. 5A is a perspective view of a device after a first process step associated with a HKMG loop, in accordance with one or more embodiments of the present disclosure.

FIG. 5B is a perspective view of the device after a second process step associated with a HKMG loop, in accordance with one or more embodiments of the present disclosure.

FIG. 5C is a perspective view of the device after a third process step associated with a HKMG loop, in accordance with one or more embodiments of the present disclosure.

FIG. 6 is a plot of XPS ground truth metrology data as a function of a delta metric for a plurality of instances of a first test feature associated with a design of experiments, in accordance with one or more embodiments of the present disclosure.

FIG. 7 is a plot of XPS ground truth metrology data as a function of a delta metric for a plurality of instances of a second test feature associated with a design of experiments, in accordance with one or more embodiments of the present disclosure.

FIG. 8 is a plot of XPS ground truth metrology data as a function of a delta metric for a plurality of instances of the test feature associated with a design of experiments, in accordance with one or more embodiments of the present disclosure.

FIG. 9A is a plot depicting metrology measurements generated via a measurement model generated without noise filtering with delta metrics as a function of ground truth metrology measurements, in accordance with one or more embodiments of the present disclosure.

FIG. 9B is a plot depicting metrology measurements generated via a measurement model generated with noise filtering with delta metrics as a function of ground truth metrology measurements, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing a metrology measurement of one or more features on a sample (referred to herein as critical parameters (CPs)) for metrology and/or inspection applications based on one or more delta metrics, where a delta metric is generated based on first measurement data from a first process step before fabricating the one or more features (e.g., a pre-process step) and second measurement data from a second process step after fabricating the one or more features (e.g., a post process step). For example, a delta metric may be associated with, but is not limited to, a root mean square error (RMSE), a difference, an absolute difference, a sum, or an absolute sum of the measurement data before and after the process step associated with fabricating the one or more features.

It is contemplated herein that the use of delta metrics may substantially increase the sensitivity and/or robustness of a measurement, particularly when features of interest are associated with a relatively minor change to the structure of the sample. In particular, the delta metrics may be strongly correlated to the structural changes associated with the features of interest. As a result, the delta metrics may either be used directly as reference data or may be used to filter (e.g., decrease the noise of) ground truth data generated with a reference metrology tool (e.g., an x-ray metrology tool, a particle-beam metrology tool, or the like).

For example, a measurement model for determining one or more metrology measurements associated with one or more features of interest may be generated using the second measurement data (e.g., associated with the post process step) and one or more delta metrics. For instance, the measurement model may be generated with the delta metrics as reference data, with reference data generated based on the delta metrics, or a combination thereof. Further, any type of measurement model may be developed including, but not limited to, a machine learning model, a physics-based model (e.g., an electromagnetic solution model), or a combination thereof.

The run-time metrology sub-system may an optical metrology sub-system with a relatively high throughput such as, but not limited to, an ellipsometer, a reflectometer, a scatterometer, a Raman spectroscopy system, a spectroscopic photoreflectance tool, a spectroscopic photoluminescence tool, or an LDSR system. The reference metrology sub-system may then provide a relatively higher accuracy but a relatively lower throughput and may include, but is not limited to, a particle-beam metrology system or an x-ray metrology system. In this configuration, a reference dataset may be generated using a fit between the ground truth data associated with a parameter of interest and a delta metric. Once the reference dataset.

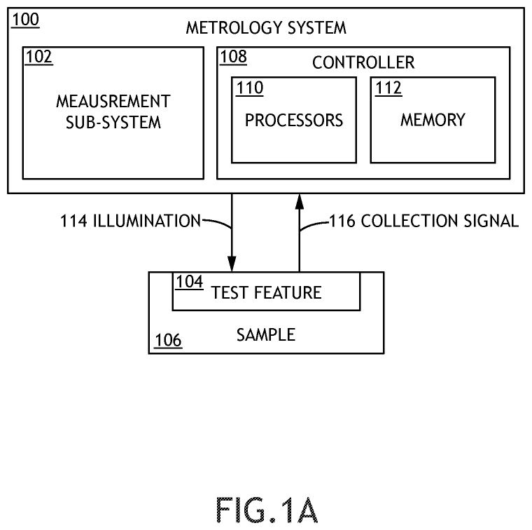

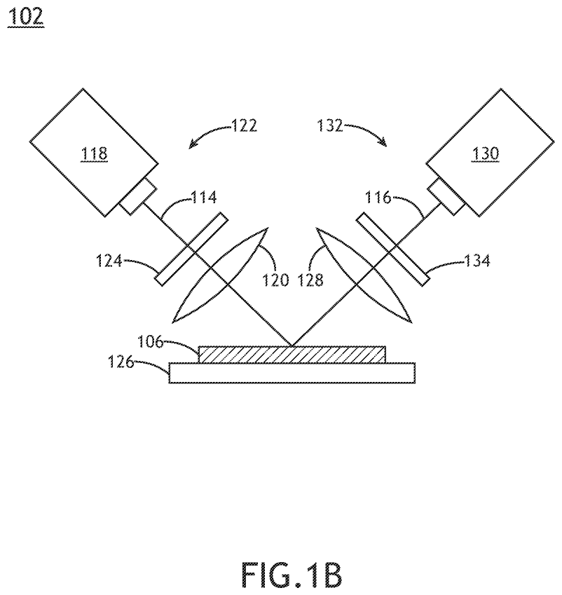

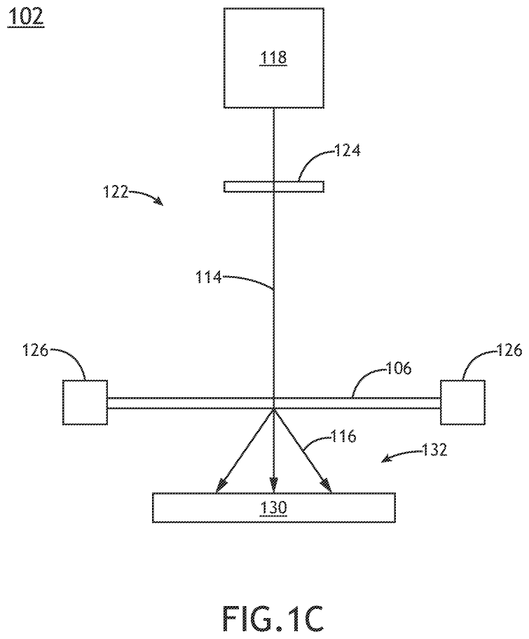

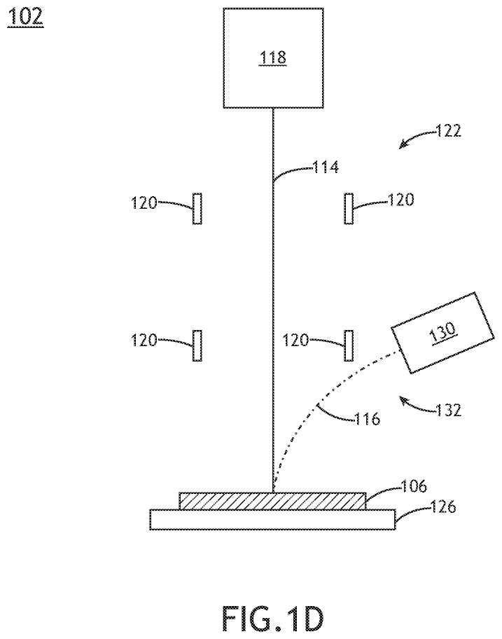

Referring now to FIGS. 1A-9B, systems and methods providing metrology based on delta metrics are described in greater detail, in accordance with one or more embodiments of the present disclosure.

FIG. 1A is a block diagram of a metrology system 100 in accordance with one or more embodiments of the present disclosure.

In some embodiments, the metrology system 100 includes one or more measurement sub-systems 102 to generate measurement datasets of a test feature 104 on a sample 106 and further includes a controller 108 to generate one or more metrology measurements associated with the based on the measurement data. The controller 108 may include one or more processors 110 configured to execute a set of program instructions maintained in a memory 112, or memory device, where the program instructions may cause the processors 110 to implement various actions.

The measurement sub-systems 102 may include any components or combination of components suitable for generating measurement data of a test feature 104. For example, a measurement sub-system 102 may direct illumination 114 to the test feature 104 and may capture a collection signal 116 from the test feature 104 in response to the illumination 114. Measurement tools for metrology and measurement techniques are generally described in U.S. Pat. No. 10,458,912 issued on October 29. 2019; U.S. Pat. No. 11,573,077 issued on Feb. 7, 2023; U.S. Pat. No. 11,036,898 issued on Jun. 15, 2021; U.S. Pat. No. 10,101,670 issued on Oct. 16, 2018; U.S. Pat. No. 10,935,893 issued on Mar. 2, 2021; U.S. Pat. No. 10,139,352 issued on Nov. 27, 2018; U.S. Pat. No. 10,152,678 issued on Dec. 11, 2018; U.S. Pat. No. 10,502,549 issued on Dec. 10, 2019; U.S. Pat. No. 9,875,946 issued on Jan. 23, 2018; U.S. Patent Publication No. 2016/0139032 published on May 19, 2016; U.S. Pat. No. 7,478,019 issued on Jan. 13, 2009; U.S. Pat. No. 7,933,026 issued on May 26, 2011; U.S. Pat. No. 5,608,526 issued on Mar. 4, 1997; U.S. Pat. No. 5,859,424 issued on Jan. 12, 1999; U.S. Pat. No. 6,429,943 issued on Aug. 6, 2002; U.S. Pat. No. 9,405,290 issued on Aug. 2, 2016; U.S. Pat. No. 9,915,522 issued on Feb. 18, 2015; U.S. Pat. No. 9,291,554 issued on Mar. 22, 2016; and U.S. Pat. No. 10,769,320 issued on Sep. 8, 2020; all of which are incorporated herein by reference in their entireties. In some embodiments, a particular measurement sub-system 102 provides multiple types of measurements. Further, multiple measurement sub-systems 102 may be provided as a single tool or multiple tools. A single tool providing multiple measurement configurations is generally described in U.S. Pat. No. 7,933,026 issued on Apr. 26, 2011, which is incorporated herein by reference in its entirety. Multiple tool and structure analysis is generally described in U.S. Pat. No. 7,478,019 issued on Jan. 13, 2009, which is incorporated herein by reference in its entirety.

In some embodiments, a measurement sub-system 102 includes an optical measurement sub-system 102 to generate measurement data based on interaction of the sample 106 with illumination 114 including light of any suitable wavelength or combination of wavelengths including, but not limited to, ultraviolet (UV) wavelengths, visible wavelengths, or infrared (IR) wavelengths. For example, an optical measurement sub-system 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), a Raman metrology tool, a laser driven spectroscopic reflectometry (LDSR) system, or any combination thereof.

In some embodiments, a measurement sub-system 102 includes an x-ray measurement sub-system 102 to generate measurement data based on interaction of the sample 106 with illumination 114 including x-rays. For example, the measurement sub-systems 102 may include, but is not limited to, a small-angle x-ray scatterometer (SAXR), or a soft x-ray reflectometer (SXR), or an x-ray photoelectron spectroscopy (XPS) system.

In some embodiments, a measurement sub-system 102 includes a particle-beam measurement sub-system 102 to generate measurement data based on interaction of the sample 106 with illumination 114 including a particle beam such as, but not limited to, an electron beam (e-beam), an ion beam, or a neutral particle beam. As an illustration, an e-beam measurement sub-system may include a scanning electron microscope (SEM), a critical dimension SEM (CD-SEM), a grey SEM (e.g., a model-based SEM similar to CD-SEM providing additional information about a measured structure such as, but not limited to, depth, height, bottom CD, or the like), or a transmission electron microscope (TEM).

Regardless of the configuration of a measurement sub-system 102, any type of collection signal 116 emanating from the test feature 104 in response to the illumination 114 may be captured to generate the measurement data such as, but not limited to, light, x-rays, or particles.

In some embodiments, the metrology system 100 includes at least an in-line measurement sub-system 102 (e.g., an in-line measurement tool) and at least one reference measurement sub-system 102 (e.g., a reference measurement tool). In a general sense, an in-line measurement sub-system 102 and/or a reference measurement sub-system may include any type of system known in the art. In some applications, a reference measurement sub-system may have a relatively higher accuracy than an in-line measurement sub-system 102, but perhaps a reduced throughput. As an illustration, an in-line measurement sub-system 102 may include an optical measurement sub-system 102 configured to capture at least some Mueller matrix elements associated with a test feature 104, while a reference measurement sub-system 102 may include an x-ray or particle-beam measurement sub-system 102. As another example, an in-line measurement sub-system 102 may include a particle-beam measurement sub-system 102 (e.g., a CD-SEM, a grey SEM, or the like), while a reference measurement sub-system 102 may include a TEM or an XPS system. It is to be understood that these examples are provided solely for illustrative purposes and should not be interpreted as limiting the present disclosure. Rather, the metrology system 100 may include an in-line measurement system 102 of any type and a reference measurement sub-system 102 of any type.

Further, multiple measurement sub-systems 102 may be provided as a single tool or multiple tools. A single tool providing multiple measurement configurations is generally described in U.S. Pat. No. 7,933,026 issued on Apr. 26, 2011, which is incorporated herein by reference in its entirety. Multiple tool and structure analysis is generally described in U.S. Pat. No. 7,478,019 issued on Jan. 13, 2009, which is incorporated herein by reference in its entirety.

The metrology system 100 may be suitable for generating any type of metrology measurement on any type of test feature 104. Further, the metrology system 100 may generate multiple metrology measurements associated with various sub-features (e.g., critical parameters) associated with a test feature 104 and/or metrology measurements associated with multiple test features 104.

For example, the test feature 104 may be associated with any stage in a fabrication process such as, but not limited to, an etch process, a lithography process, or a deposition process. Non-limiting examples of a test feature 104 includes, but are not limited to, a patterned multi-layer structure, a patterned single-layer structure (e.g., a grating structure, or the like), a film stack (e.g., an unpatterned film stack), or a combination thereof. Further, non-limiting examples of a metrology measurements include, but are not limited to, a CD measurement, a height measurement (e.g., a height of a patterned feature, a height of a multi-layer feature, or the like), an overlay measurement, a tilt measurement, an electrical test measurement (e.g., Vt, work-function, mobility, Ion/Ioff, or the like), a stress or strain measurement, a film thickness, or a material property measurement (e.g., a refractive index measurement, a spectroscopic measurement, or the like).

The controller 108 may be communicatively coupled to any components of the metrology system 100 including, but not limited to, the one or more measurement sub-systems 102. In this way, the controller 108 may receive communication (e.g., data, instructions, or the like) from any connected components and/or may direct connected components (e.g., via control signals) to perform selected actions. The controller 108 may thus directly or indirectly implement any desired actions.

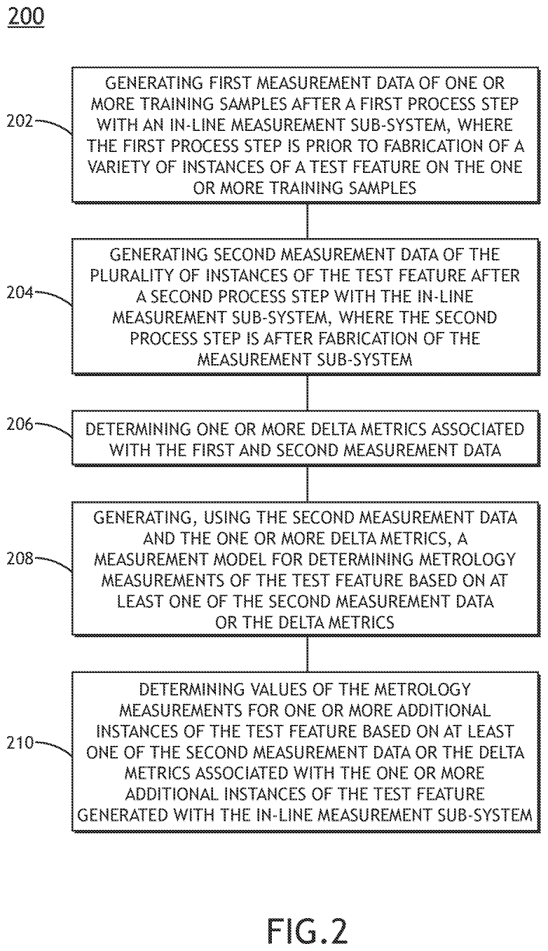

FIG. 2 is a flow diagram depicting steps performed in a metrology method 200, in accordance with one or more embodiments of the present disclosure. The embodiments and enabling technologies described herein in the context of the metrology system 100 should be interpreted to extend to the method 200. For example, the one or more processors 110 of the controller 108 may implement program instructions (e.g., stored on the memory 112) causing the processors 110 to implement any of the steps of the method 200 directly or indirectly. However, the method 200 is not limited to the architecture of the metrology system 100. In this way, examples of the implementation of the method 200 herein are merely illustrative and should not be interpreted as limiting the scope of the present disclosure.

In some embodiments, the method 200 includes a step 202 of generating first measurement data of one or more training samples after a first process step with an in-line measurement sub-system 102 (or a first measurement sub-system 102 more generally), where the first process step is prior to fabrication of a variety of instances of a test feature 104 on the one or more training samples. In some embodiments, the method 200 includes a step 204 of generating second measurement data of the plurality of instances of the test feature 104 after a second process step with the in-line measurement sub-system 102, where the second process step is after fabrication of the measurement sub-system 102. Further, the variety of instances of the test feature 104 may provide a distribution of intentional variations of one or more aspects of the test feature 104. Put another way, the second measurement data from step 204 may be associated with a design of experiments (DOE) in which the test feature 104 is fabricated with intentional processing variations that result in intentional deviations of various aspects of the test feature. In this way, the second measurement data may provide training data associated with known variations of aspects of the test feature 104 that are relevant to in-line metrology.

In some embodiments, the method 200 includes a step 206 of determining one or more delta metrics associated with the first and second measurement data. Any particular delta metric may be associated with any combination of the first and second measurement data that is indicative of the test feature 104. For example, a delta metric may be associated with a RMSE, a difference, an absolute difference, a sum, or an absolute sum of the first and second measurement data. Further, the step 206 may include generating any number of delta metrics (e.g., one or more delta metrics) associated with different mathematical combinations of the first and second measurement data. Still further, the step 206 is not limited to determining delta metrics associated with a single test feature 104. In some embodiments, the step 206 includes determining delta metrics associated with two or more test features 104.

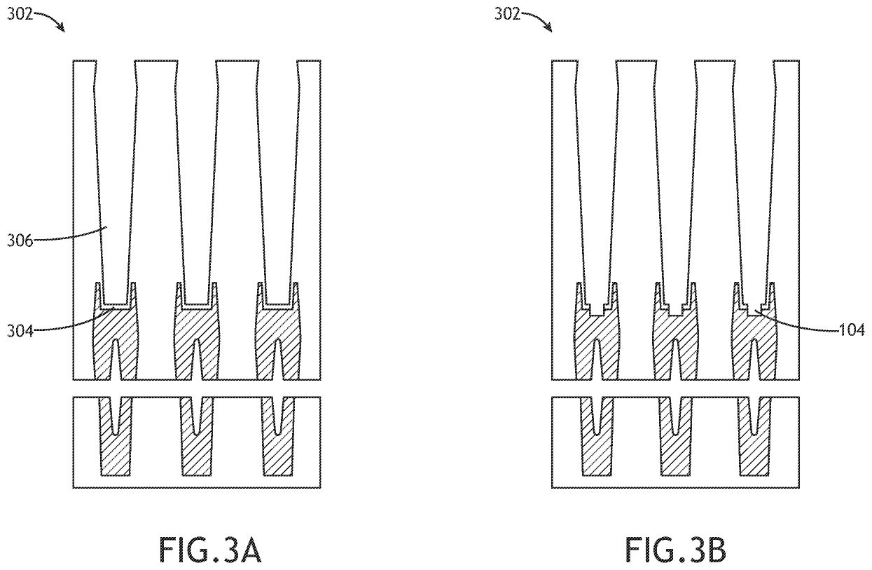

FIGS. 3A-5C depict various non-limiting examples of test features 104 that may benefit from characterization using delta metrics as depicted in the method 200. It is contemplated herein that delta metrics based on measurement data generated before and after the fabrication of a test feature 104 may be highly correlated with the test feature 104. Further, delta metrics may be particularly valuable when the test feature 104 corresponds to a relatively subtle change to the sample 106. In these applications, measurement data from a measurement sub-system 102 of any type (e.g., an in-line measurement sub-system 102 or even a reference measurement sub-system 102) may be weak and/or noisy.

FIGS. 3A-3B depict an example in which the test feature 104 is associated with a bottom open recess. In particular, FIG. 3A is a cross-section view of a VNAND device 302 after a first process step (e.g., a pre-process step) prior to fabricating a bottom open recess test feature 104, in accordance with one or more embodiments of the present disclosure. FIG. 3B is a cross-section view of the VNAND device 302 of FIG. 3A after a second process step (e.g., a post-process step) fabricating a bottom open recess test feature 104, in accordance with one or more embodiments of the present disclosure. As illustrated in FIGS. 3A-3B, the structural difference between the VNAND device 302 before and after fabricating the bottom open recess is relatively minor and is related to removal of material 304 at the bottom of cavity structures 306. It is thus expected that a difference between first and second measurement data associated with these first and second process steps will also be relatively small. As a result, typical techniques for developing a measurement model to generate metrology measurements of this bottom open recess test feature 104 are expected to suffer from poor correlation and high noise. However, it is contemplated herein that a measurement model incorporating delta metrics may provide high correlation and relatively low noise.

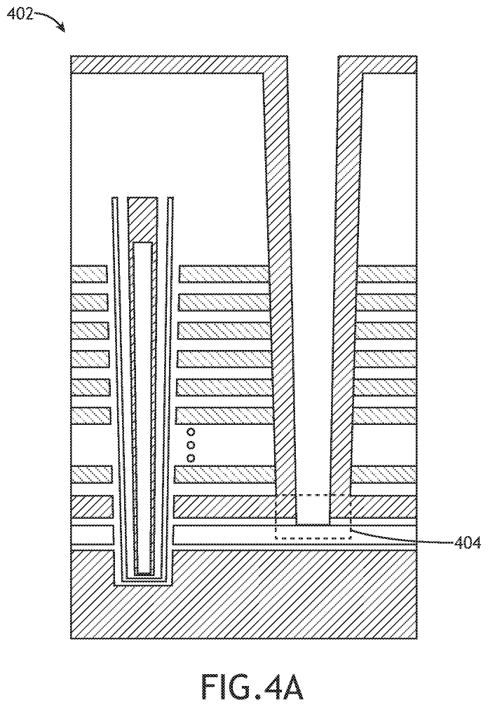

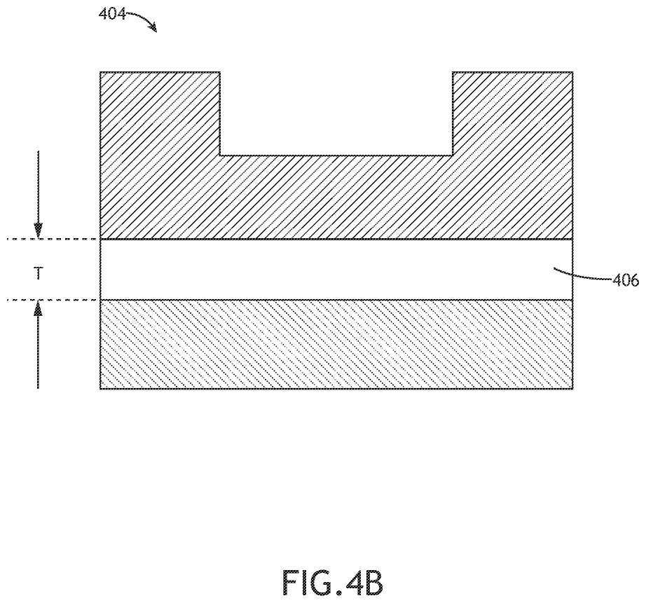

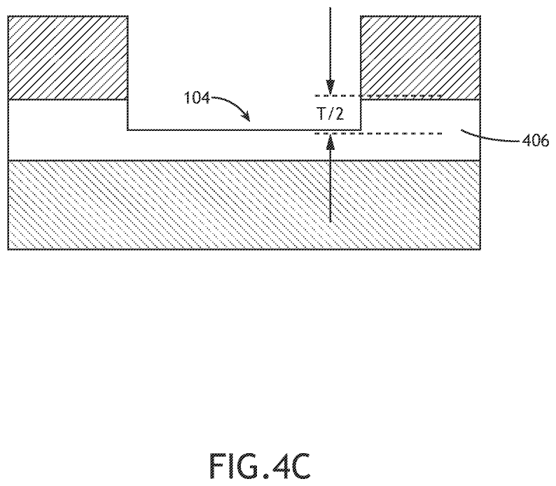

FIGS. 4A-4C depict an example in which the test feature 104 is a recess test feature 104 associated with a pre poly liner of a VNAND device 402, in accordance with one or more embodiments of the present disclosure. FIG. 4A is a cross-section view of a VNAND device 402 after a first process step (e.g., a pre-process step) prior to fabricating a recess test feature 104, in accordance with one or more embodiments of the present disclosure. FIG. 4B is a magnified view of a portion 404 of FIG. 4A after the first process step, in accordance with one or more embodiments of the present disclosure. FIG. 4C is a magnified view of the portion 404 of FIG. 4A after a second process step (e.g., a post-process step) forming the recess test feature 104, in accordance with one or more embodiments of the present disclosure. In particular, the recess test feature 104 may correspond to a partial etch of a SiO₂ layer 406. In a manner similar to the bottom open recess test feature 104 depicted in FIGS. 3A-3B, it is contemplated herein that the use of delta metrics to generate a measurement model to characterize the recess test feature 104 depicted in FIGS. 4A-4C may provide higher correlation and lower noise than existing techniques.

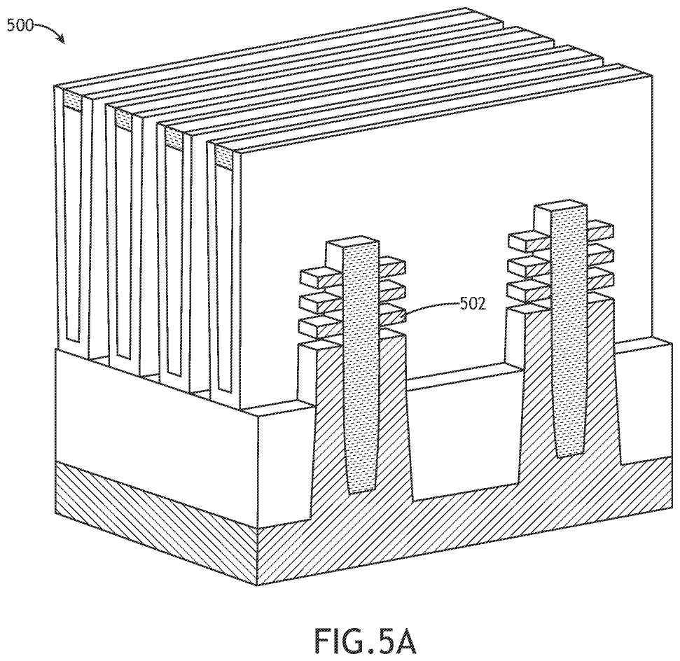

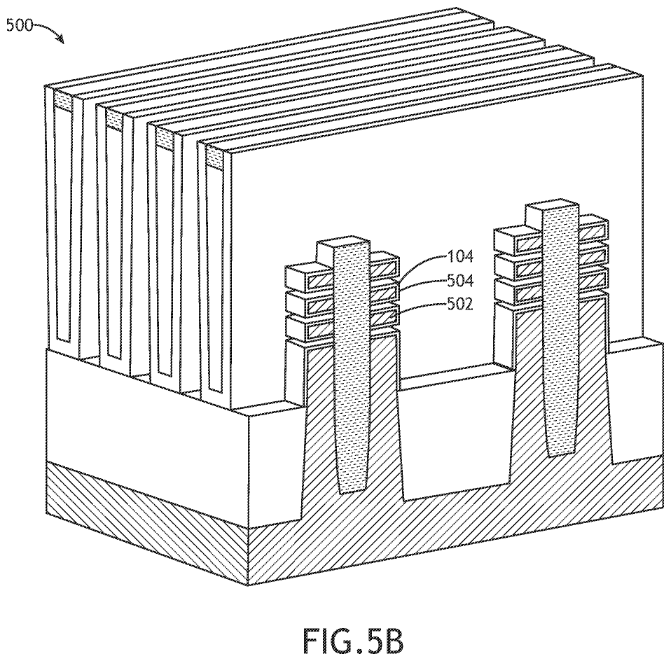

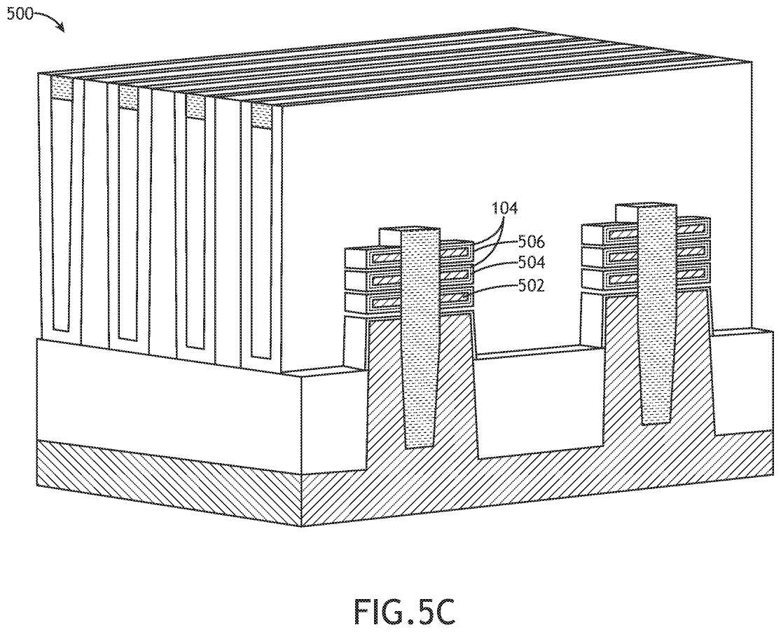

FIGS. 5A-5C depict an example of various test features 104 associated with critical steps for high k metal gate (HKMG) fabrication. The HKMG process is at the end of the front end of the line loop (FEOL) of the CMOS device. After dummy-gate removal and oxide strip and clean, a series of ultra-thin materials are deposited on the gate prior to the deposition of the metal. These materials' optical dispersion characteristics are comparable, and they are frequently quite thin. An 8 to 10 A SiO₂ interface layer (IL) is typically first deposited on the gate (and fin). Hafnium dioxide (e.g., with a thickness of 14 A) is used as a high-k material after that. This is followed by a barrier metal TaN (e.g., 5 to 10 A), then another TiN layer, followed by TiAIC, and finally a 10 A TiN work function material. Further, different HKMG process flows are required for PMOS and NMOS devices, which complicates matters and increases the number of crucial layers. Atomic Layer Deposition (ALD) is a typical process used to create the depositions.

It is noted that typical techniques for characterizing such devices have focused on measuring planar film stacks (e.g., with x-ray based techniques). However, these typical techniques suffer from insufficient accuracy and/or sensitivity.

FIG. 5A is a perspective view of a device 500 after a first process step associated with a HKMG loop, in accordance with one or more embodiments of the present disclosure. In particular, FIG. 5A illustrates a nanosheet release step in which nanosheets 502 are formed. FIG. 5B is a perspective view of the device 500 after a second process step associated with a HKMG loop, in accordance with one or more embodiments of the present disclosure. In particular, FIG. 5B illustrates an interface layer deposition step, where an interface layer 504 is deposited over the nanosheets 502. FIG. 5C is a perspective view of the device 500 after a third process step associated with a HKMG loop, in accordance with one or more embodiments of the present disclosure. In particular, FIG. 5C illustrates high-k layer deposition step, where a high-k layer 506 is deposited over the interface layer 504.

It is contemplated herein that the method 200 may be implemented to generate metrology measurements for any of the process steps depicted in FIGS. 5A-5C. For example, metrology measurements of the interface layer 504 as a test feature 104 may be provided based on delta metrics between the steps depicted in FIGS. 5A and 5B. As another example, metrology measurements of the high-k layer 506 as a test feature 104 may be provided based on delta metrics between the steps depicted in FIGS. 5B and 5C.

Referring now generally to FIGS. 3A-5C, it is to be understood that FIGS. 3A-5C are provided solely for illustrative purposes and should not be interpreted as limiting the scope of the present disclosure. Rather, the method 200 may be implemented to provide metrology measurements for any number or type of test features 104.

Referring again to FIG. 2, in some embodiments, the method 200 includes a step 208 of generating, using the second measurement data and the one or more delta metrics, a measurement model for determining metrology measurements of the test feature 104 based on at least one of the second measurement data or the delta metrics. In some embodiments, the method 200 includes a step 210 of determining values of the metrology measurements for one or more additional instances of the test feature 104 based on at least one of the second measurement data or the delta metrics associated with the one or more additional instances of the test feature 104 generated with the in-line measurement sub-system 102.

The steps 208 and 210 may utilize any type or combination of types of measurement models.

In some embodiments, the measurement model is a physics-based measurement model. For example in a case where the in-line measurement sub-system 102 is an optical measurement sub-system 102, the measurement model may include an electromagnetic solver based on algorithms such as, but not limited to, rigorous coupled-wave analysis (RCWA) techniques, finite element method (FEM) techniques, method of moments techniques, surface integral techniques, volume integral techniques, finite different time domain (FDTD) techniques, or the like.

In some embodiments, the measurement model is a machine learning model.

The machine learning models may incorporate any type or combination of machine learning techniques such as, but not limited to, supervised machine learning techniques, semi-supervised machine learning techniques, reinforcement machine learning techniques, or unsupervised machine learning techniques. As an illustration, a machine learning model may include, is not limited to, a linear model, a neural network model, a polynomial model, a decision tree model, or a random forest model. In some applications, training data may include a combination of experimental and simulated data.

A machine learning model may accept any type of input data suitable for determining metrology measurements of an instance of a test feature 104 based on at least one of second measurement data or delta metrics associated with the instance of the test feature 104.

For example, a machine learning model may accept measurement data (e.g., raw data) associated with a particular measurement configuration. As an illustration, a spectrometry-based optical measurement sub-system 102 may generate signals associated with 15 Mueller matrix elements, with approximately 670 wavelength pixels per signal to provide approximately 10,000 individual signals for a particular measurement configuration. This is merely illustrative, however, and should not be interpreted as limiting the scope of the present disclosure. For example, such a system may generate signals associated with any number of Mueller matrix elements (e.g., up to 16 Mueller matrix elements) and provide any number of datapoints for any number of wavelengths. Further, as described above, the method 200 is not limited to optical measurement sub-systems 102.

As another example, a particular machine learning model may accept principal components (PCs) associated with a subset or a transformation of a measurement dataset associated with a particular measurement configuration. In some embodiments, the method 200 includes a step (not shown) of extracting principal component sets (e.g., features) from at least one of the second metrology data or the delta metrics (e.g., input data to the machine learning model generally), where the machine learning model generates the metrology measurements based on the principal component sets. In this way, the step of extracting the principal component sets from the input data may provide dimensionality reduction of the associated measurement datasets. The principal component sets may correspond to a subset of input data or a transformation of the input data. The step of extracting the principal component sets from the measurement datasets may be implemented using any suitable technique including, but not limited to, a principal component analysis (PCA) (e.g., linear or non-linear) or a fast Fourier Transform (FFT) analysis. In a general sense, the principal component set may correspond to aspects of the associated measurement data that are correlated with the metrology measurements.

More generally, it is contemplated herein that delta metrics may be used in different ways to develop the measurement model in step 208.

As described previously herein, the delta metrics may be highly correlated to the test feature 104, even when the test feature 104 is associated with a relatively minor structural change to the sample 106. In this way, the delta metrics may be used either directly or indirectly as reference data for the measurement model.

In some embodiments, the delta metrics are used to filter ground-truth data associated with ground-truth measurements of training instances of the test feature 104 characterized in steps 202 and 204. For example, method 200 may include additional steps of receiving ground-truth metrology measurements of the one or more features after the one or more second process steps with a reference measurement sub-system 102 different than the in-line measurement sub-system 102, and generating reference data based on the ground-truth metrology measurements and the delta metrics. In this way, the measurement model generated in step 208 may be based on both the second metrology metrics and this reference data.

For example, the reference measurement sub-system 102 may be an x-ray measurement sub-system 102, a particle-beam measurement sub-system 102, or the like suitable for generating ground-truth metrology measurements with a higher accuracy than achievable with the in-line measurement sub-system 102. However, it is contemplated herein that even the ground truth metrology measurements may have noise or relatively low sensitivity for certain test features 104, particularly when the test features 104 are associated with a minor structural change to the sample 106. In this case, the delta metrics may be used to filter the ground-truth data to reduce noise and generate a more robust set of reference data for the measurement model. In some embodiments, the method 200 includes determining a fitting function relating the ground-truth metrology measurements to the delta metrics, and generating reference data based on the fitting function.

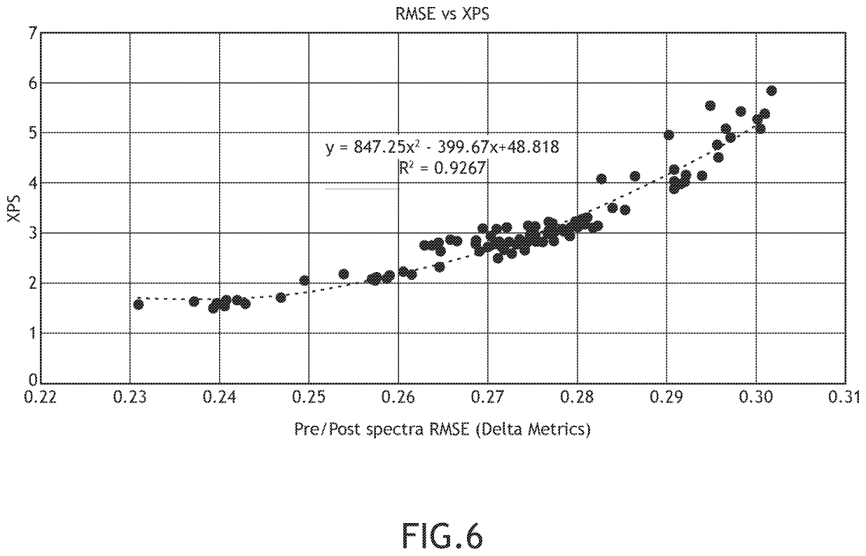

FIGS. 6-9B depict the use of delta metrics to generate reference data by filtering ground-truth metrology measurements, in accordance with one or more embodiments of the present disclosure. Further, FIGS. 6-9B are based on the HKMG loop depicted in FIGS. 5A-5C.

FIG. 6 is a plot of XPS ground truth metrology data as a function of a delta metric for a plurality of instances of a first test feature 104 associated with a design of experiments, in accordance with one or more embodiments of the present disclosure. In FIG. 6, the first measurement data is associated with a step after fabricating HKMG TIN layer, whereas the second measurement data is associated with a step after fabricating a HKMG TiAIC layer. The delta metrics are generated as an RMSE between first and second measurement data (e.g., associated with steps 202 and 204 of the method 200). In FIG. 6, the ground truth XPS data are fit with a polynomial function to the RMSE delta metrics. In this way, new reference data (e.g., to be used for the development of the measurement model) may be generated using the fitting function rather than the ground-truth metrology measurements themselves.

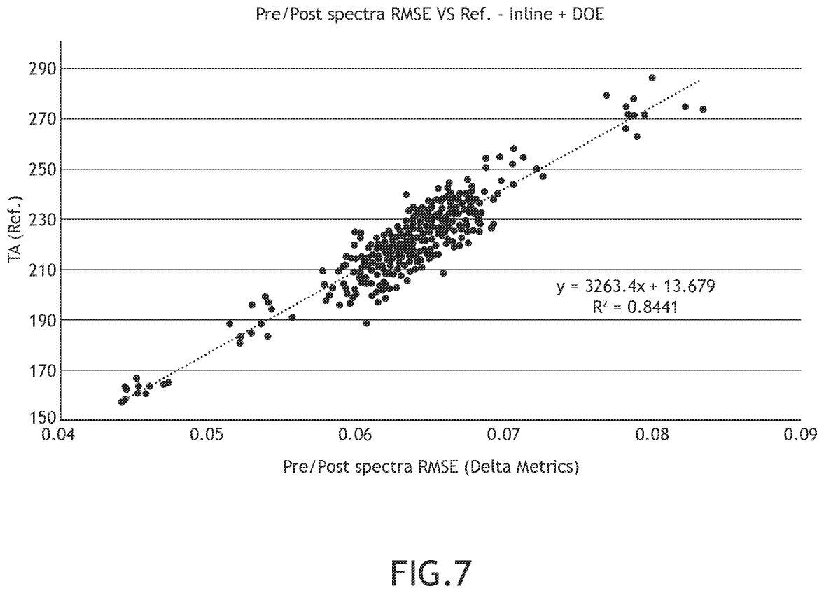

FIG. 7 is a plot of XPS ground truth metrology data as a function of a delta metric for a plurality of instances of a second test feature 104 associated with a design of experiments, in accordance with one or more embodiments of the present disclosure. In FIG. 7, the first measurement data is associated with a step after fabricating HKMG high-k layer, whereas the second measurement data is associated with a step after fabricating a HKMG TiN layer. The delta metrics are generated as an RMSE between first and second measurement data (e.g., associated with steps 202 and 204 of the method 200). In FIG. 7, the ground truth XPS data are fit with a polynomial function (here, a linear function) to the RMSE delta metrics. In this way, new reference data (e.g., to be used for the development of the measurement model) may be generated using the fitting function rather than the ground-truth metrology measurements themselves. Further, FIG. 7 includes data for instances of the second test feature 104 associated with both design of experiments data (e.g., instances of the second test feature 104 with intentional variations) as well as instances of the second test feature 104 from in-line samples that are not part of a training dataset.

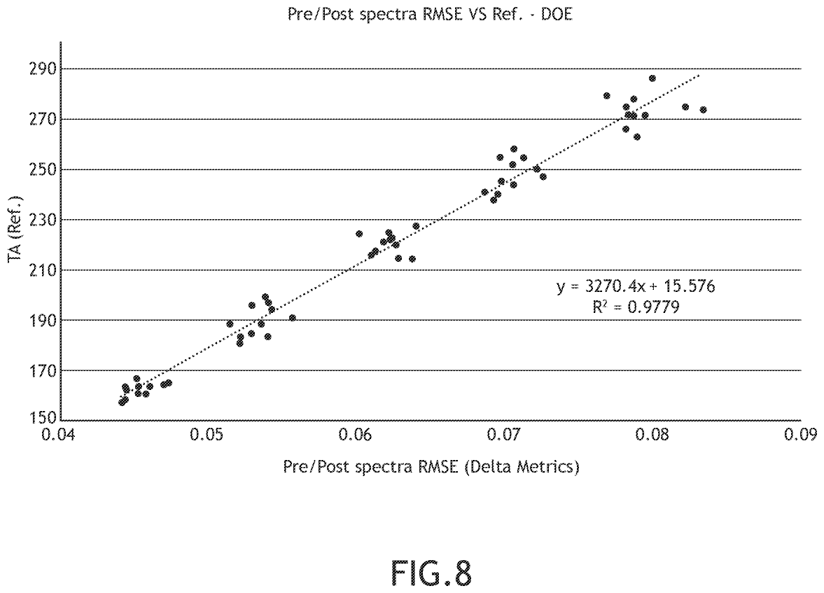

FIG. 8 is a plot of XPS ground truth metrology data as a function of a delta metric for a plurality of instances of the test feature 104 associated with a design of experiments, in accordance with one or more embodiments of the present disclosure. FIG. 8 is substantially similar to FIG. 7 except that it only includes instances of the test feature 104 associated with the design of experiments data. By comparing FIGS. 7 and 8, it is clear that the polynomial fitting function accurately describes the in-line data as well as the design of experiments data.

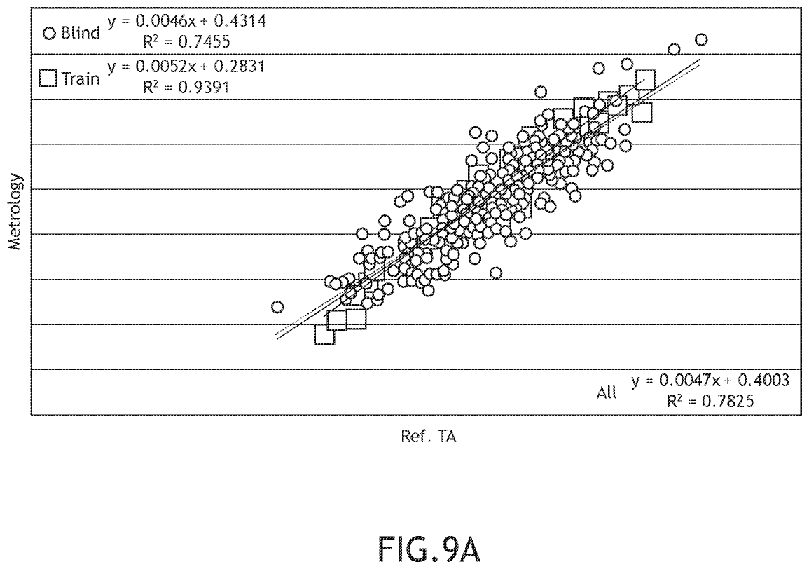

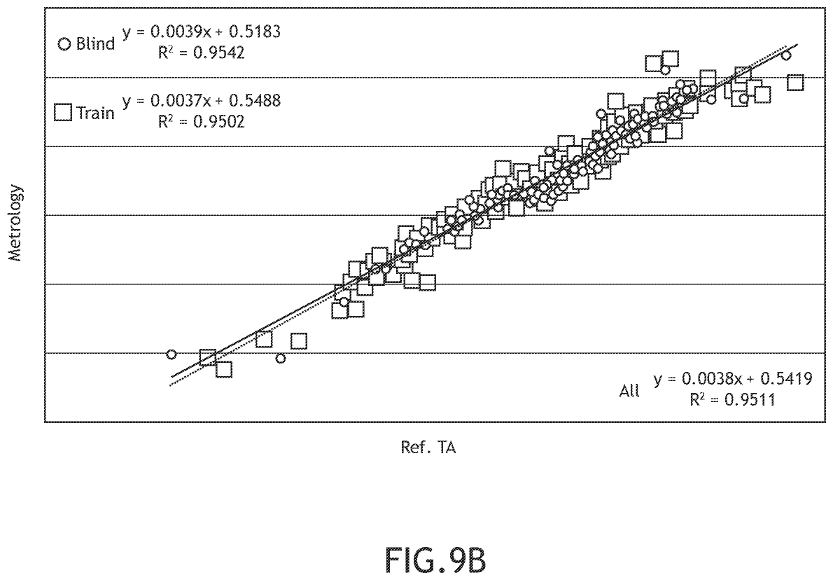

FIGS. 9A-9B depict blind test data demonstrating the effectiveness of a measurement model (e.g., from step 208) in determining metrology measurements of blind data (e.g., instances of the test feature 104 for which ground-truth metrology measurements are obtained but not used to train the measurement model). FIG. 9A is a plot depicting metrology measurements (on the Y axis) generated via a measurement model generated without noise filtering with delta metrics as a function of ground truth metrology measurements (on the X axis), in accordance with one or more embodiments of the present disclosure. FIG. 9B is a plot depicting metrology measurements (on the Y axis) generated via a measurement model generated with noise filtering with delta metrics (e.g., based on fitting of ground truth metrology measurements to delta metrics as described previously herein) as a function of ground truth metrology measurements (on the X axis), in accordance with one or more embodiments of the present disclosure. As illustrated in FIGS. 9A-9B, the use of delta metrics to generate filtered reference data for a measurement model provides an accurate and robust solution without the need for high numbers of reference measurements. In particular, the R2 value increased from 0.74 to 0.95 by using the delta metrics for reference measurement filtering. For example, typical current techniques may require hundreds of reference data points, whereas the systems and methods disclosed herein may converge with substantially fewer reference data points when using the delta metrics.

Referring again generally to FIG. 2, in some embodiments, the delta metrics are used directly as reference data for the generation of a measurement model (e.g., in step 208 of the method 200). For example, the step 208 of generating a measurement model may include training a machine learning model with delta metrics. For example, such a model may be trained (e.g., in step 208) with delta metrics and second measurement data (e.g., data after the post-processing step associated with a test feature 104) for various instances of the test feature 104 with varied characteristics in a design of experiments. Then, the model may be used (e.g., in step 210) to generate metrology measurements using the second measurement data and/or delta metrics generated with in-line samples.

Referring now to FIGS. 1A-1D, additional aspects of the metrology system 100 are described in greater detail, in accordance with one or more embodiments of the present disclosure.

The one or more processors 110 of a controller 108 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 110 may include any device configured to execute algorithms and/or instructions (e.g., program instructions stored in memory). In some embodiments, the one or more processors 110 may be embodied as a desktop computer, mainframe computer system, workstation, image computer, parallel processor, networked computer, or any other computer system configured to execute a program configured to operate or operate in conjunction with the measurement sub-systems 102, as described throughout the present disclosure. Moreover, different subsystems of the metrology system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 108 may include one or more controllers housed in a common housing or within multiple housings. In this way, any controller or combination of controllers may be separately packaged as a module suitable for integration into metrology system 100.

The memory 112 may include any storage medium known in the art suitable for storing program instructions executable by the associated one or more processors 110. For example, the memory 112 may include a non-transitory memory medium. By way of another example, the memory 112 may include, but is not limited to, a read-only memory (ROM), a random-access memory (RAM), a magnetic or optical memory device (e.g., disk), a magnetic tape, a solid-state drive and the like. It is further noted that the memory 112 may be housed in a common controller housing with the one or more processors 110. In some embodiments, the memory 112 may be located remotely with respect to the physical location of the one or more processors 110 and the controller 108. For instance, the one or more processors 110 of the controller 108 may access a remote memory (e.g., server), accessible through a network (e.g., internet, intranet and the like).

FIGS. 1B-1D depict variations of measurement sub-systems 102, in accordance with one or more embodiments of the present disclosure.

FIG. 1B is a simplified schematic of an optical measurement sub-system 102, in accordance with one or more embodiments of the present disclosure. For example, the measurement sub-systems 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), or any combination thereof.

In some embodiments, the measurement sub-systems 102 includes an illumination source 118 configured to generate illumination 114 in the form of at least one illumination beam. The illumination 114 from the illumination source 118 may include one or more selected wavelengths of light including, but not limited to, ultraviolet (UV) radiation, visible radiation, or infrared (IR) radiation. Further, the spatial profile of the illumination 114 on the sample 106 may be controlled by a field-plane stop to have any selected spatial profile.

The illumination source 118 may include any type of illumination source suitable for providing illumination 114 formed from light. In some embodiments, the illumination source 118 is a laser source. For example, the illumination source 118 may include, but is not limited to, one or more narrowband laser sources, a broadband laser source, a supercontinuum laser source, a white light laser source, or the like. In some embodiments, the illumination source 118 includes a laser-sustained plasma (LSP) source. For example, the illumination source 118 may include, but is not limited to, a LSP lamp, a LSP bulb, or a LSP chamber suitable for containing one or more elements that, when excited by a laser source into a plasma state, may emit broadband illumination. In some embodiments, the illumination source 118 includes a lamp source. In some embodiments, the illumination source 118 may include, but is not limited to, an arc lamp, a discharge lamp, an electrode-less lamp, or the like.

The illumination source 118 may provide the illumination 114 using free-space techniques and/or optical fibers.

In some embodiments, the measurement sub-systems 102 directs the illumination 114 to the sample 106 through at least one illumination lens 120 (e.g., an objective lens) via an illumination pathway 122. The illumination pathway 122 may include one or more optical components suitable for modifying and/or conditioning the illumination 114 as well as directing the illumination 114 to the sample 106. In some embodiments, the illumination pathway 122 includes one or more illumination-pathway optics 124 to shape or otherwise control the illumination 114. For example, the illumination-pathway optics 124 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may position the sample 106 for a measurement using any suitable technique. In some embodiments, as illustrated in FIG. 1B, the measurement sub-systems 102 includes a sample stage 126 including one or more actuators (e.g., linear actuators, tip/tilt actuators, rotational actuators, or the like) to position the sample 106 with respect to the illumination beam. In some embodiments, though not explicitly shown, the measurement sub-systems 102 includes beam-scanning optics (e.g., galvanometer mirrors, scanning prisms, or the like) to adjust a position and/or scan one or more beams of illumination 114.

In some embodiments, the measurement sub-systems 102 includes at least one collection lens 128 to capture collection signal 116 (e.g., light), and direct this collection signal 116 to one or more detectors 130 through a collection pathway 132. The collection pathway 132 may include one or more optical elements suitable for modifying and/or conditioning the collection signal 116 from the sample 106. In some embodiments, the collection pathway 132 includes one or more collection-pathway optics 134 to shape or otherwise control the collection signal 116. For example, the collection-pathway optics 134 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may generally include any number or type of detectors 130. For example, the measurement sub-systems 102 may include at least one single-pixel detector 130 such as, but not limited to, a photodiode, an avalanche photodiodes, or a single-photon detectors. As another example, the measurement sub-systems 102 may include at least one mutli-pixel detector 130 such as, but not limited to, a charge-coupled device (CCD) or a complementary metal-oxide semiconductor (CMOS) device, a line detector, or a time-delay integration (TDI) detector.

A detector 130 may be located at any selected location within the collection pathway 132. In some embodiments, the measurement sub-systems 102 includes a detector 130 at a field plane (e.g., a plane conjugate to the sample 106) to generate an image of the sample 106. In some embodiments, the measurement sub-systems 102 includes a detector 130 at a pupil plane (e.g., a diffraction plane) to generate a pupil image. In this regard, the pupil image may correspond to an angular distribution of light from the sample 106 detector 130. For instance, diffraction orders associated with diffraction of the illumination 114 from the sample 106 may be imaged or otherwise observed in the pupil plane. In a general sense, a detector 130 may capture any combination of reflected (or transmitted), scattered, or diffracted light from the sample 106.

The illumination pathway 122 and the collection pathway 132 of the measurement sub-systems 102 may be oriented in a wide range of configurations. For example, as illustrated in FIG. 1B, the illumination pathway 122 and the collection pathway 132 may contain non-overlapping optical paths. In some embodiments, though not explicitly shown, the measurement sub-systems 102 may include a beamsplitter oriented such that a common objective lens may simultaneously direct the illumination 114 to the sample 106 and capture collection signal 116.

FIG. 1C is a simplified schematic of an x-ray measurement sub-system 102, in accordance with one or more embodiments of the present disclosure. Such a measurement sub-systems 102 may be configured as, but is not limited to, a SAXR, a SXR, or an XPS system. X-ray characterization systems and associated measurement techniques are generally described in U.S. Pat. No. 7,929,667 issued on Apr. 19, 2011; U.S. Pat. No. 9,885,962 issued on Feb. 6, 2018; U.S. Pat. No. 10,013,518 issued on Jul. 3, 2018; U.S. Pat. No. 10,324,050 issued on Jun. 18, 2019; U.S. Pat. No. 10,352,695 issued on Jul. 16, 2019; U.S. Pat. No. 10,775,323 issued on Sep. 15, 2020; Germer, et al., “Intercomparison between optical and x-ray scatterometry measurements of FinFET structures” Proc. SPIE, v.8681, p. 86810Q (2013); Kline, et al. “X-ray scattering critical dimensional metrology using a compact x-ray source for next generation semiconductor devices.” Journal of Micro/Nanolithography, MEMS, and MOEMS 16.1 (2017); U.S. Pat. No. 11,333,621 issued on May 17, 2022; and U.S. Patent Application No. 2021/0207956 published on Jul. 8, 2021; all of which are incorporated herein by reference in their entireties.

In some embodiments, the illumination source 118 is an x-ray source configured to generate x-ray illumination 114 having any particle energies (e.g., soft x-rays, hard x-rays, or the like). The measurement sub-systems 102 may then include any combination of components suitable for capturing an associated collection signal 116, which may include, but is not limited to, x-ray emissions, optical emissions, or particle emissions.

For example, the measurement sub-systems 102 may include at least one x-ray illumination lens 120 and/or illumination-pathway optics 124 suitable for collimating or focusing x-ray illumination 114. Although not shown, the measurement sub-system 102 may further include at least one x-ray collection pathway lens and/or collection-pathway optics suitable for collecting, collimating, and/or focusing the collection signal 116 from the sample 106. Further, the measurement sub-systems 102 may include various illumination-pathway optics 124 and/or collection-pathway optics 134 such as, but not limited to, x-ray collimating mirrors, specular x-ray optics such as grazing incidence ellipsoidal mirrors, polycapillary optics such as hollow capillary x-ray waveguides, multilayer optics, or systems, or any combination thereof. In embodiments, the measurement sub-systems 102 includes an x-ray detector 130 such as, but not limited to, an x-ray monochromator (e.g., a crystal monochromator such as a Loxley-Tanner-Bowen monochromator, or the like), x-ray apertures, x-ray beam stops, or diffractive optics (e.g., such as zone plates).

FIG. 1D is a simplified schematic of a particle beam measurement sub-system 102, in accordance with one or more embodiments of the present disclosure. Such a measurement sub-systems 102 may be configured as, but is not limited to, a SEM, a CD-SEM, a grey SEM, or a TEM.

In some embodiments, the illumination source 118 includes a particle source (e.g., an electron beam source, an ion beam source, or the like) such that the illumination 114 includes a particle beam (e.g., an electron beam, a particle beam, or the like). The illumination source 118 may include any particle source known in the art suitable for generating particle illumination 114. For example, the illumination source 118 may include, but is not limited to, an electron gun or an ion gun. In some embodiments, the illumination source 118 is configured to provide a particle beam with a tunable energy. For example, an illumination source 118 including an electron source may, but is not limited to, provide an accelerating voltage in the range of 0.1 kV to 30 kV. As another example, an illumination source 118 including an ion source may, but is not required to, provide an ion beam with an energy in the range of 1 to 50 keV.

In some embodiments, the measurement sub-system 102 includes one or more particle focusing elements. For example, the one or more particle focusing elements may include, but are not limited to, a single particle focusing element or one or more particle focusing elements forming a compound system. In some embodiments, the one or more particle focusing elements include illumination lens 120 configured to direct the particle illumination beam to the sample 106. Further, the one or more particle focusing elements may include any type of electron lenses known in the art including, but not limited to, electrostatic, magnetic, uni-potential, or double-potential lenses.

In some embodiments, the measurement sub-systems 102 includes one or more particle detectors 130 to image or otherwise detect particles emanating from the sample 106. For example, the detector 130 may include an electron collector (e.g., a secondary electron collector, a backscattered electron detector, or the like). As another example, the detector 130 may include a photon detector (e.g., a photodetector, an x-ray detector, a scintillating element coupled to photomultiplier tube (PMT) detector, or the like) for detecting electrons and/or photons from the sample surface.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An inspection system comprising:
a controller including one or more processors configured to execute program instructions causing the one or more processors to:
receive first measurement data of one or more training samples after a first process step with an in-line measurement sub-system, wherein the first process step is prior to fabrication of a plurality of instances of a test feature on the one or more training samples;
receive second measurement data of the plurality of instances of the test feature after a second process step with the in-line measurement sub-system, wherein the second process step is after the fabrication of the plurality of instances of the test feature, wherein the plurality of instances of the test feature provide a distribution of intentional variations of one or more aspects of the test feature;
determine one or more delta metrics associated with the first and second measurement data for the plurality of instances of the test feature;
generate, using the second measurement data and the one or more delta metrics, a measurement model for determining metrology measurements of the test feature based on at least one of the second measurement data or the one or more delta metrics; and
determine values of the metrology measurements for one or more additional instances of the test feature based on at least one of the second measurement data or the one or more delta metrics associated with the one or more additional instances of the test feature generated with the in-line measurement sub-system.

2. The inspection system of claim 1, wherein the one or more delta metrics are based on at least one of a root mean square error (RMSE), a difference, an absolute difference, a sum, or an absolute sum of the first and second measurement data.

3. The inspection system of claim 1, wherein the program instructions are further configured to cause the one or more processors to:
receive ground-truth metrology measurements of the plurality of instances of the test feature after the second process step with a reference measurement sub-system different than the in-line measurement sub-system; and
generate reference data based on the ground-truth metrology measurements and the one or more delta metrics, wherein generate, using the second measurement data and the one or more delta metrics, the measurement model for determining metrology measurements of the plurality of instances of the test feature based on at least the second measurement data comprises:
generate, using the second measurement data and the reference data, the measurement model for determining metrology measurements of the plurality of instances of the test feature based on at least the second measurement data.

4. The inspection system of claim 3, wherein generate the reference data based on the ground-truth metrology measurements and the one or more delta metrics comprises:
determine a fitting function relating the ground-truth metrology measurements to the one or more delta metrics; and
generate the reference data based on the fitting function.

5. The inspection system of claim 3, wherein the in-line measurement sub-system comprises:
an optical measurement sub-system.

6. The inspection system of claim 5, wherein the reference measurement sub-system comprises:
at least one of an x-ray measurement sub-system or a particle-beam measurement sub-system.

7. The inspection system of claim 3, wherein the in-line measurement sub-system comprises:
a particle-beam measurement sub-system.

8. The inspection system of claim 7, wherein the reference measurement sub-system comprises:
at least one of an x-ray photon spectrometer system or a transmission electron microscope system.

9. The inspection system of claim 3, wherein the measurement model comprises:
a machine learning model trained on the second measurement data and at least one of the one or more delta metrics or the reference data.

10. The inspection system of claim 3, wherein the in-line measurement sub-system comprises an optical measurement sub-system, wherein the measurement model comprises an electromagnetic model.

11. The inspection system of claim 10, wherein the electromagnetic model comprises:
a rigorous coupled-wave analysis (RCWA) model.

12. The inspection system of claim 1, wherein the measurement model comprises:
a machine learning model trained on the second measurement data and the one or more delta metrics.

13. The inspection system of claim 1, wherein the in-line measurement sub-system comprises an optical measurement sub-system, wherein the measurement model comprises an electromagnetic model.

14. The inspection system of claim 13, wherein the electromagnetic model comprises:
a rigorous coupled-wave analysis (RCWA) model.

15. The inspection system of claim 1, wherein the in-line measurement sub-system comprises:
an optical measurement sub-system.

16. The inspection system of claim 15, wherein the optical measurement sub-system is configured to determine at least some Mueller matrix elements associated with the plurality of instances of the test feature.

17. The inspection system of claim 1, wherein the in-line measurement sub-system comprises:
an optical measurement sub-system.

18. The inspection system of claim 1, wherein the in-line measurement sub-system comprises:
an x-ray measurement sub-system.

19. An inspection method comprising:
generating first measurement data of one or more training samples after a first process step with an in-line measurement sub-system, wherein the first process step is prior to fabrication of a plurality of instances of a test feature on the one or more training samples;
generating second measurement data of the plurality of instances of the test feature after a second process step with the in-line measurement sub-system, wherein the second process step is after the fabrication of the plurality of instances of the test feature, wherein the plurality of instances of the test feature provide a distribution of intentional variations of one or more aspects of the test feature;
determining one or more delta metrics associated with the first and second measurement data for the plurality of instances of the test feature;
generating, using the second measurement data and the one or more delta metrics, a measurement model for determining metrology measurements of the test feature based on at least one of the second measurement data or the one or more delta metrics; and
determining values of the metrology measurements for one or more additional instances of the test feature based on at least one of the second measurement data or the one or more delta metrics associated with the one or more additional instances of the test feature generated with the in-line measurement sub-system.

20. An inspection system comprising:
an in-line measurement sub-system;
a reference measurement sub-system; and
a controller including one or more processors configured to execute program instructions causing the one or more processors to:
receive first measurement data of one or more training samples after a first process step with the in-line measurement sub-system, wherein the first process step is prior to fabrication of a plurality of instances of a test feature on the one or more training samples;
receive second measurement data of the plurality of instances of the test feature after a second process step with the in-line measurement sub-system, wherein the second process step is after the fabrication of the plurality of instances of the test feature, wherein the plurality of instances of the test feature provide a distribution of intentional variations of one or more aspects of the test feature;
determine one or more delta metrics associated with the first and second measurement data for the plurality of instances of the test feature;
receive ground-truth metrology measurements of the plurality of instances of the test feature after the one or more second process steps with the reference measurement sub-system;
generate reference data based on the ground-truth metrology measurements and the one or more delta metrics;
generate, using the second measurement data and the reference data, a measurement model for determining metrology measurements of the plurality of instances of the test feature based on at least the second measurement data; and
determine values of the metrology measurements for one or more additional instances of the test feature based on at least one of the second measurement data or the one or more delta metrics associated with the one or more additional instances of the test feature generated with the in-line measurement sub-system.

21. The inspection system of claim 20, wherein generate the reference data based on the ground-truth metrology measurements and the one or more delta metrics comprises:
determine a fitting function relating the ground-truth metrology measurements to the one or more delta metrics; and
generate the reference data based on the fitting function.

22. The inspection system of claim 20, wherein the in-line measurement sub-system comprises:
an optical measurement sub-system.

23. The inspection system of claim 22, wherein the optical measurement sub-system is configured to determine at least some Mueller matrix elements associated with the plurality of instances of the test feature.

24. The inspection system of claim 22, wherein the reference measurement sub-system comprises:
at least one of an x-ray measurement sub-system or a particle-beam measurement sub-system.

25. The inspection system of claim 20, wherein the in-line measurement sub-system comprises:
a particle-beam measurement sub-system.

26. The inspection system of claim 25, wherein the in-line measurement sub-system comprises:
a critical dimension scanning electron microscope system.

27. The inspection system of claim 26, wherein the reference measurement sub-system comprises:
at least one of an x-ray photon spectrometer system or a transmission electron microscope system.

28. The inspection system of claim 20, wherein the in-line measurement sub-system comprises:
an x-ray measurement sub-system.
